(19) United States
(12) Patent Application Publication
(10) Pub. No.: US 2015/0014893 A1
(43) Pub. Date: Jan. 15, 2015

(54) PROCESS FOR PRODUCING ARTICLE HAVING FINE PATTERN ON ITS SURFACE

(71) Applicant: ASAHI GLASS COMPANY, LIMITED, Tokyo (JP)

(72) Inventors: Kosuke TAKAYAMA, Tokyo (JP); Hiroshi SAKAMOTO, Tokyo (JP); Yuriko KAIDA, Tokyo (JP); Shinji OKADA, Tokyo (JP); Yasuhide KAWAGUCHI, Tokyo (JP)

(73) Assignee: ASAHI GLASS COMPANY, LIMITED, Tokyo (JP)

(21) Appl. No.: 14/496,935

(22) Filed: Sep. 25, 2014

Related U.S. Application Data
(63) Continuation of application No. PCT/JP2013/060653, filed on Apr. 8, 2013.

(30) Foreign Application Priority Data
Apr. 9, 2012 (JP) 2012-088633

(51) Int. Cl. B29C 59/02; B29C 59/16

(52) U.S. Cl. CPC B29C 59/022; B29C 59/16; B29K 2063/00
USPC 264/447

(57) ABSTRACT

To provide a process for producing an article having a fine pattern on its surface, by which peeling of a cured resin layer having a fine pattern is suppressed, and a defect of the cured resin layer by repelling when a photocurable resin composition is applied is suppressed.

A process comprising (a) a step of applying a solution of a silane coupling agent to the surface of a substrate 12 to form a primer layer 14, (b) a step of applying a photocurable resin composition to the surface of the primer layer 14 to form a photocurable resin layer 18, (c) a step of irradiating the photocurable resin layer 18 with light in a state such that the photocurable resin layer 18 is sandwiched between a mold 30 having on its surface a reverse pattern of a fine pattern 20 and the primer layer 14 to form a cured resin layer 16, and (d) a step of separating the mold 30 from the cured resin layer 16 to obtain an article 10, wherein the solution of a silane coupling agent contains a silane coupling agent having a (meth)acryloyloxy group and a silane coupling agent having an epoxy group.

### TECHNICAL FIELD

The present invention relates to a process for producing an article having a fine pattern on its surface by a nanoimprint lithography method.

### BACKGROUND ART

As a method for forming a resist having a predetermined pattern to be used as a mask in etching process in production of a semiconductor device or the like, a nanoimprint lithography method has attracted attention.

As a method for forming a resist by a nanoimprint lithography method, for example, the following method has been known.

A method wherein a photoresist (photocurable resin composition) is applied to the surface of a substrate, the photoresist is irradiated with light in a state where the photoresist is sandwiched between the substrate and a mold having a reverse pattern of a predetermined pattern on its surface to cure the photoresist, and the mold is separated to form a resist having the predetermined pattern (cured resin layer having a fine pattern) on the surface of the substrate.

In the nanoimprint lithography method, it is necessary that the resist is not peeled from the substrate when the mold is separated, and therefore adhesion between the substrate and the resist is important. Particularly, the resist is likely to be peeled from the substrate when the mold is separated, in a case where the resist is thin (for example at most 200 nm), the reverse pattern on the mold is fine, the reverse pattern on the mold has a high aspect ratio, or the mold has a large area, and accordingly in such cases, high adhesion between the substrate and the resist is required.

In order to secure the adhesion between the substrate and the resist, prior to application of the photoresist to the surface of the substrate, a solution of a silane coupling agent is applied to the surface of the substrate to preliminarily form a primer layer. For example, a silane coupling agent having an epoxy group or a silane coupling agent having a (meth)acryloyloxy group is applied to the surface of a silica glass substrate to form a primer layer (Patent Document 1), or a silane coupling agent having a (meth)acryloyloxy group is applied to the surface of a silicon substrate to form a primer layer (Patent Document 2).

### PRIOR ART DOCUMENTS

### Patent Documents

Patent Document 1: JP-A-2007-313880

Patent Document 2: JP-A-2011-222732

### DISCLOSURE OF INVENTION

### Technical Problem

Although the silane coupling agent having an epoxy group has good adhesion to a substrate, it is inferior in the adhesion to a resist and is particularly inferior in the adhesion to a (meth)acrylate type photoresist (photocurable resin composition) widely used as a resist for nanoimprint, and accordingly it is usually not used as a primer layer in formation of a resist.

A silane coupling agent having a (meth)acryloyloxy group has good adhesion to a substrate and a resist and is thereby suitably used as a primer layer in formation of a resist.

However, it was found that when a diluted solution of a silane coupling agent having a (meth)acryloyloxy group is applied to a non-washed silicon substrate, the silane coupling agent is repelled, and a primer layer cannot be uniformly formed on the surface of the substrate. Accordingly, the resist is likely to be peeled at a portion where formation of the primer layer is insufficient.

According to studies by the present inventors, it was found that by incorporating a tetraalkoxysilane in a diluted solution of a silane coupling agent having a (meth)acryloyloxy group, repelling of the silane coupling agent can be suppressed.

However, in a case where a tetraalkoxysilane is incorporated in a diluted solution of a silane coupling agent, a photoresist applied to the surface of the primer layer is repelled, and a problem newly arose that said portion becomes a defect of the resist (the substrate is exposed). Repelling of the photoresist is remarkable in a case where the resist is thin (for example at most 200 nm), the application method is an application method of uniformly applying the photoresist to form a thin film in an area of at least 10 mm², such as a spin coating method, a die coating method, a dip coating method, a spray coating method, a blade coating method, a bar coating method, a roll coating method or a gravure coating method, or the resist is a solution containing a solvent and particularly when heat drying is required.

The present invention provides a process for producing an article having a fine pattern on its surface, by which peeling of the cured resin layer having a fine pattern is suppressed, and a defect of the cured resin layer by repelling when the photocurable resin composition is applied is suppressed.

### Solution to Problem

The process for producing an article having a fine pattern on its surface of the present invention is a process for producing an article comprising a substrate, a primer layer formed on the surface of the substrate and a cured resin layer formed on the surface of the primer layer, the cured resin layer having a fine pattern, the process comprising:

(a) a step of applying a solution of a silane coupling agent to the surface of the substrate to form the primer layer;

(b) a step of applying a photocurable resin composition to the surface of the primer layer to form a photocurable resin layer;

(c) a step of irradiating the photocurable resin layer with light in a state such that the photocurable resin layer is sandwiched between a mold having on its surface a reverse pattern of the fine pattern and the primer layer to cure the photocurable resin layer thereby to form the cured resin layer; and

(d) a step of separating the mold from the cured resin layer to obtain the article;

wherein as the solution of a silane coupling agent, one containing a silane coupling agent having a (meth)acryloyloxy group and a silane coupling agent having an epoxy group is used.

It is preferred that the proportion of the silane coupling agent having a (meth)acryloyloxy group is from 1 to 99 mass % per 100 mass % of the total amount of the silane coupling agent having a (meth)acryloyloxy group and the silane coupling agent having an epoxy group in the solution of a silane coupling agent.

The photocurable resin composition preferably contains a fluorinated surfactant in an amount of from 0.05 to 5 mass % of the composition.

The photocurable resin composition preferably contains a compound having a (meth)acryloyloxy group.

The method of applying the photocurable resin composition is preferably a method capable of forming the photocurable resin layer in an area of at least 10 mm².

In the process for producing an article having a fine pattern on its surface of the present invention, it is preferred that the photocurable resin composition containing a solvent is applied to the surface of the primer layer and heated to at least 60° C. to evaporate the solvent, thereby to form the photocurable resin layer.

The material of the substrate is preferably silicon, silica glass or glass.

In this specification, “to” used to show the range of the numerical values is used to include the numerical values before and after it as the lower limit value and the upper limit value, and unless otherwise specified, the same applies hereinafter.

### Advantageous Effects of Invention

According to the process for producing an article having a fine pattern on its surface of the present invention, peeling of the curable resin layer having a fine pattern is suppressed, and a defect of the cured resin layer by repelling when the photocurable resin composition is applied is suppressed.

### BRIEF DESCRIPTION OF DRAWINGS

FIG. 1 is a cross sectional view illustrating an example of an article having a fine pattern on its surface obtainable by the production process of the present invention.

FIG. 2 is a cross sectional view illustrating each step in a process for producing an article having a fine pattern on its surface of the present invention.

FIG. 3 is a cross sectional view illustrating a step of directly forming a fine pattern on the surface of a substrate by means of etching using a cured resin layer having a fine pattern as a resist.

### DESCRIPTION OF EMBODIMENTS

In this specification, definition is made as follows.

A fine pattern and a reverse pattern mean a shape consisting of at least one convex and/or concave with a minimum dimension of from 1 nm to 100 μm among the width, the length and the height (i.e. depth).

A (meth)acryloyloxy group means an acryloyloxy group or a methacryloyloxy group.

A (meth)acrylate means an acrylate or a methacrylate.

A silane coupling agent means a compound having a functional group capable of being reacted with an organic material (for example, a functional group such as a (meth)acryloyloxy group or an epoxy group) and a hydrolysable silyl group capable of forming a silanol group by hydrolysis in the same molecule.

### Article Having Fine Pattern on its Surface

An article having a fine pattern on its surface obtainable by the production process of the present invention comprises a substrate, a primer layer formed on the surface of the substrate and a cured resin layer formed on the surface of the primer layer, wherein the cured resin layer has a fine pattern.

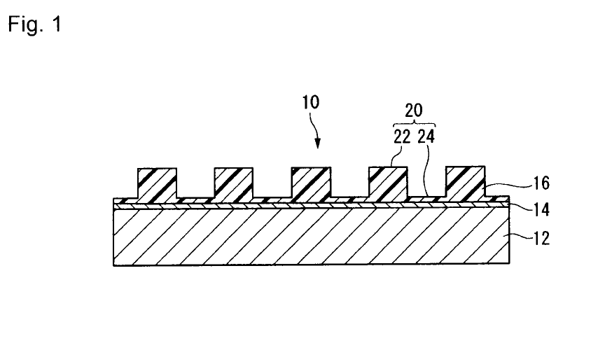

FIG. 1 is a cross sectional view illustrating an example of an article having a fine pattern on its surface. An article 10 comprises a substrate 12, a primer layer formed on the surface of the substrate 12 and a cured resin layer 16 formed on the surface of the primer layer 14. The cured resin layer 16 has a fine pattern 20 consisting of a plurality of convexes 22 and concaves 24 between the convexes 22.

### (Substrate)

As the material of the substrate 12, silicon (such as single crystalline silicon, polysilicon or amorphous silicon), silica glass, glass, silicon nitride, aluminum nitride, silicon carbide, sapphire, lithium niobate, lithium tantalate, a metal (such as aluminum, nickel or copper), a metal oxide (such as alumina, zinc oxide or magnesium oxide), one comprising such a substrate and an oxide layer and/or a metal layer (for example, one containing as the main component e.g. chromium, aluminum, nickel, molybdenum, tantalum, tungsten, ITO, tin oxide, gold, silver, copper, platinum or titanium) formed on the surface of the substrate, or a resin may, for example, be mentioned. As the material of the substrate 12, preferred is silicon, silica glass or glass from the following regions.

In the present invention, the substrate 12 may be a thin substrate having flexibility or may be a thick plate substrate, and the thickness is not limited. In view of transport and handling efficiency, the thickness of the substrate 12 is preferably from 0.05 to 10 mm, more preferably from 0.10 to 6.35 mm.

The substrate 12 may be subjected to surface treatment with a view to further improving the adhesion to the primer layer 14. The surface treatment may, for example, be ozone treatment, ultraviolet washing treatment, plasma treatment, corona treatment, flame treatment, ITRO treatment (a kind of combustion chemical vapor deposition developed by ITRO Co., Ltd.) or SPM (sulfuric acid hydrogen peroxide mixture) treatment.

### (Primer Layer)

The primer layer 14 is a layer formed by applying a solution of a silane coupling agent mentioned hereinafter to the surface of the substrate 12, drying the solution, and reacting a silanol group formed by hydrolysis of a hydrolysable silyl group of the silane coupling agent with a functional group (such as a hydroxy group) on the surface of the substrate 12.

### (Cured Resin Layer)

The cured resin layer 16 is a layer formed by applying a photocurable resin composition mentioned hereinafter to the surface of the primer layer 14, and by light irradiation, curing a part or the whole of a photocurable compound contained in the photocurable resin composition and reacting a part of the photocurable compound with a functional group (such as a (meth)acryloyloxy group) derived from the silane coupling agent on the surface of the primer layer 14.

### (Fine Pattern)

The cured resin layer 16 has a fine pattern 20 on its surface. The fine pattern 20 is a pattern formed by transcription of a reverse pattern on the surface of a mold mentioned hereinafter.

The fine pattern 20 comprises a plurality of convexes 22 and concaves 24 between the convexes 22. The concaves 22 may, for example, be convex lines extending on the surface of the cured resin layer 16 or protrusions dotted on the surface.

The shape of the convex lines may, for example, be linear, curved or bent. The convex lines may be a plurality of stripes extending in parallel with one another.

The cross-sectional shape of the convex lines in a direction perpendicular to the longitudinal direction may, for example, be rectangular, trapezoidal, triangular or semicircular.

The shape of the protrusions may, for example, be triangular prism, quadrangular prism, hexagonal column, cylindrical column, triangular pyramid, quadrangular pyramid, hexagonal pyramid, circular corn, hemispherical or polyhedral.

The width of the convex lines is preferably from 1 nm to 100 μm, more preferably from 1 nm to 10 μm, particularly preferably from 10 nm to 500 nm. The width of the convex lines means the full width at half maximum in the cross section in a direction perpendicular to the longitudinal direction.

The width of the protrusions is preferably from 1 nm to 100 μm, more preferably from 1 nm to 10 μm, particularly preferably from 10 nm to 500 nm. The width of the protrusions means the full width at half maximum in the cross section in a direction perpendicular to the longitudinal direction, in a case where the bottom side is elongated, or otherwise, means the minimum length of a line which passes the center of gravity in a horizontal section at a position of half the height of the protrusion, in a case where the bottom side is not elongated.

The height of the convexes 22 is preferably from 1 nm to 100 μm, more preferably from 1 nm to 10 μm, further preferably from 10 nm to 500 nm.

In an area where the fine pattern 20 is dense, the distance between the adjacent concaves 22 is preferably from 1 nm to 100 μm, more preferably from 1 nm to 10 μm, further preferably from 10 nm to 1 μm. The distance between the adjacent concaves 22 means the distance from the terminal edge of the bottom in the cross section of one concave 22 to the starting edge of the bottom in the cross section of the adjacent convex 22.

The above respective dimensions are averages of dimensions measured at 3 portions.

The minimum dimension of a convex 22 is preferably from 1 nm to 100 μm, more preferably from 1 nm to 10 μm, particularly preferably from 10 nm to 500 μm. The minimum dimension means the minimum dimension among the width, length and height of the convex.

### Process for Producing Article Having Fine Pattern on its Surface

The process for producing an article having a fine pattern on its surface of the present invention is a process comprising the following steps (a) to (d).

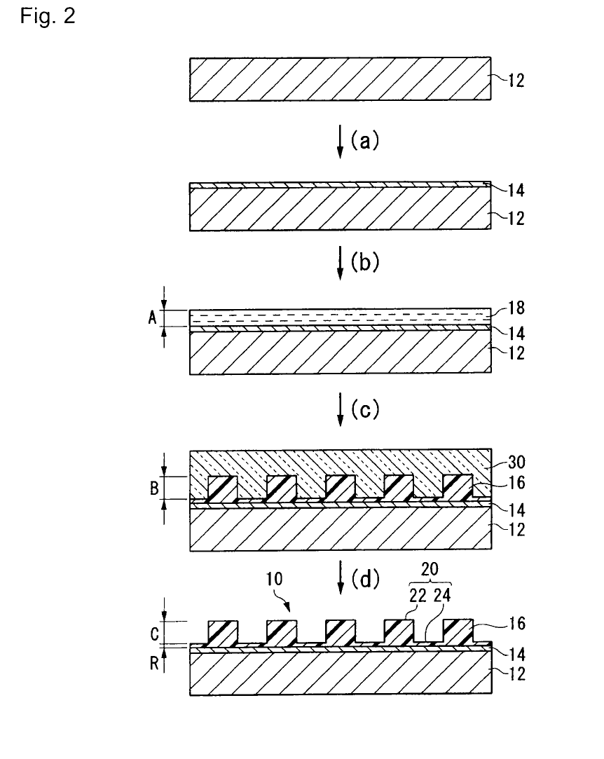

(a) A step of applying a solution of a silane coupling agent to the surface of a substrate 12 to form a primer layer 14 as shown in FIG. 2.

(b) A step of applying a photocurable resin composition to the surface of the primer layer 14 to form a photocurable resin layer 18, after the step (a), as shown in FIG. 2.

(c) A step of irradiating the photocurable resin layer 18 with light in a state such that the photocurable resin layer 18 is sandwiched between a mold 30 having on its surface a reverse pattern of the above-described fine pattern 20 and the primer layer 14 to cure the photocurable resin layer 18 thereby to form a cured resin layer 16, after the step (b), as shown in FIG. 2.

(d) A step of separating the mold 30 from the cured resin layer 16 to obtain an article 10, after the step (c), as shown in FIG. 2.

### Step (a)

A solution of a silane coupling agent is applied to the surface of a substrate 12 and dried, and a silanol group formed by hydrolysis of a hydrolysable silyl group of the silane coupling agent is reacted with a functional group (such as a hydroxy group) on the surface of the substrate 12 to form a primer layer 14.

### (Substrate)

As the substrate 12, one made of the above-described material may be mentioned. The material of the substrate 12 is preferably silicon, silica glass or glass. In a case where the material of the substrate 12 is silicon, silica glass or glass, repelling of a silane coupling agent having a (meth)acryloyloxy group is likely to occur. Thus, effects by the present invention tend to be remarkable by applying the production process of the present invention when the material of the substrate 12 is silicon, silica glass or glass.

At least one of the substrate 12 and the mold 30 is a material which transmits at least 40% of light having a wavelength with which a photopolymerization initiator of the photocurable resin composition is reactive.

### (Solution of Silane Coupling Agent)

The solution of a silane coupling agent contains a silane coupling agent and a solvent, and as the case requires, a catalyst which promotes hydrolysis of a hydrolysable silyl group of the silane coupling agent, another silane compound, or the like.

As the solution of a silane coupling agent, one containing a silane coupling agent having a (meth)acryloyloxy group and a silane coupling agent having an epoxy group is used.

The hydrolysable silyl group of the silane coupling agent may, for example, be preferably at least one member selected from the group consisting of —Si(OCH₃₎₃, —SiCH₃(OCH₃)₂, —Si(OCH₂CH₃)₃, —SiCl₃, —Si(OCOCH₃)₃ and —Si(NCO)₃.

The silane coupling agent having a (meth)acryloyloxy group may, for example, be preferably at least one member selected from the group consisting of 3-methacryloxypropyltrimethoxysilane, 3-acryloxypropyltrimethoxysilane, 3-methacryloxypropylmethyldimethoxysilane, 3-methacryloxypropylmethyldiethoxysilane and 3-methacryloxypropyltriethoxysilane.

The silane coupling agent having an epoxy group may, for example, be preferably at least one member selected from the group consisting of 2-(3,4-epoxycyclohexypethyltrimethoxysilane, 3-glycidoxypropyltrimethoxysilane and 3-glycidoxypropylmethyldimethoxysilane.

By the solution of a silane coupling agent containing the silane coupling agent having a (meth)acryloyloxy group, peeling of the cured resin layer 16 can be suppressed as compared with a case where the silane coupling agent having a (meth)acryloyloxy group is not contained. Further, by the solution of a silane coupling agent containing the silane coupling agent having an epoxy group in addition to the silane coupling agent having a (meth)acryloyloxy group, repelling of the silane coupling agent having a (meth)acryloyloxy group when applied to the surface of the substrate 12 can be suppressed as compared with a case where the silane coupling agent having an epoxy group is not contained.

That is, an effect to suppress peeling of the cured resin layer 16 can be obtained by adding the silane coupling agent having a (meth)acryloyloxy group even in a very small amount to the silane coupling agent having an epoxy group. Further, an effect to suppress repelling of the silane coupling agent can be obtained by adding the silane coupling agent having an epoxy group even in a very small amount to the silane coupling agent having a (meth)acryloyloxy group.

Accordingly, in order to obtain the effects of the present invention even if only slightly, the proportion of the silane coupling agent having a (meth)acryloyloxy group is from 1 to 99 mass %, preferably from 1 to 80 mass % per 100 mass % of the total amount of the silane coupling agent having a (meth)acryloyloxy group and the silane coupling agent having an epoxy group. The optimum range of the proportion of the silane coupling agent having a (meth)acryloyloxy group to obtain sufficient effects of the present invention varies depending upon the substrate 12, the photocurable resin composition, the shape or the size of the reverse pattern on the mold 30, the type of the silane coupling agent or the like, and cannot generally be refined, but the range to sufficiently obtain the effects of the present invention regardless of the material is particularly preferably from 5 to 60 mass %.

Similarly, the proportion of the silane coupling agent having an epoxy group in the solution of a silane coupling agent is from 1 to 99 mass %, preferably from 30 to 99 mass % per 100 mass % of the total amount of the silane coupling agent having a (meth)acryloyloxy group and the silane coupling agent having an epoxy group. The optimum range of the proportion of the silane coupling agent having an epoxy group to sufficiently obtain the effects of the present invention is particularly preferably from 40 to 95 mass %.

Further, particularly when glass is used as the substrate, in view of the effect to suppress repelling of the silane coupling agent by a contaminant on the glass surface, particularly preferred is use of 3-methacryloxypropyltrimethoxysilane and 2-(3,4-epoxycyclohexyl)ethyltrimethoxysilane in combination.

The solution of a silane coupling agent may contain another silane coupling agent other than the silane coupling agent having a (meth)acryloyloxy group and the silane coupling agent having an epoxy group within a range not to impair the effects of the present invention. Further, in order to sufficiently obtain the effects of the present invention, the solution of a silane coupling agent preferably contains another silane coupling agent as little as possible, and more preferably contains only the silane coupling agent having a (meth)acryloyloxy group and the silane coupling agent having an epoxy group as the silane coupling agent.

The proportion of the silane coupling agent having a (meth)acryloyloxy group and the silane coupling agent having an epoxy group in the solution of a silane coupling agent is preferably from 0.01 to 2 mass %, more preferably from 0.1 to 1 mass % per 100 mass % of the solution of a silane coupling agent. When the proportion of the silane coupling agent is at least 0.01 mass %, the silane coupling agent can sufficiently cover the substrate 12, thus improving the adhesion. Further, when the proportion of the silane coupling agent is at most 2 mass %, it is possible to prevent formation of aggregates in the solution of a silane coupling agent when the solution is prepared, and the solution can be stabilized.

The solvent may, for example, be water, an alcohol (such as methanol, ethanol, 2-propanol, n-propanol, butanol, pentanol, hexanol or ethylene glycol), an ether (such as diethyl ether, dimethyl ether, methyl ethyl ether or tetrahydrofuran) or a ketone (such as acetone, methyl ethyl ketone, methyl isobutyl ketone or cyclohexanone). The solvent is particularly preferably water, methanol, ethanol, 2-propanol or n-propanol in view of controllability of the hydrolysis reaction, the solubility, the boiling point of the solvent, and the safety for the humane body.

The solution of a silane coupling agent preferably contains a catalyst which promotes hydrolysis of the hydrolysable silyl group of the silane coupling agent.

The catalyst may, for example, be an acid catalyst or a basic catalyst.

The acid catalyst may, for example, be hydrochloric acid, nitric acid, acetic acid, sulfuric acid, phosphoric acid, sulfonic acid, methane sulfonic acid or p-toluene sulfonic acid.

The basic catalyst may, for example, be sodium hydroxide, potassium hydroxide, ammonia or triethylamine.

The proportion of the catalyst is preferably from 0.005 to 1 mass % per 100 mass % of the solution of a silane coupling agent.

The solution of a silane coupling agent may contain another silane compound other than the silane coupling agent within a range not to impair the effects of the present invention.

Such another silane compound may, for example, be a tetraalkoxysilane (such as tetraethoxysilane), a trialkoxymonoalkylsilane, a dialkoxydialkylsilane or a monoalkoxytrialkylsilane. In a case where a tetraalkoxysilane is contained, repelling of the photocurable resin composition applied to the surface of the primer layer 14 is likely to occur, and accordingly in order to sufficiently obtain the effects of the present invention, the solution of a silane coupling agent is preferably one containing another silane compound as little as possible, more preferably one containing no another silane compound.

### (Formation of Primer Layer)

The method of applying the solution of a silane coupling agent may, for example, be a spin coating method, a die coating method, a dip coating method, a spray coating method, an ink jet method, a potting method, a roll coating method, a blade coating method, a gravure coating method, a casting method or a bar coating method.

The solution of a silane coupling agent is preferably subjected to filtration using a filter having a pore size of from 0.1 to 5 μm immediately before application.

It is preferred that after the solution of a silane coupling agent is applied to the surface of the substrate 12, the coating layer of the solution of a silane coupling agent is dried. The temperature for drying the coating layer is preferably from 80 to 150° C., more preferably from 100 to 130° C. When the drying temperature is at least 80° C., the drying time tends to be short, and the reaction between the silane coupling agent and the substrate 12 tends to proceed. When the drying temperature is at most 150° C., heat decomposition reaction of the silane coupling agent can be suppressed. The drying time is preferably from 30 seconds to 20 minutes, more preferably from 2 minutes to 10 minutes.

The primer layer 14 develops its adhesion performance by forming a monomolecular layer by adsorption reaction to the substrate 12 surface. When the above application method is employed, a film thicker than a monomolecular layer is formed in many cases, however, if the primer layer 14 is too thin, peeling may occur by the cohesive fracture in the primer layer 14, and the presence of the primer layer 14 may be non-negligible in the nanoimprint lithography method. Accordingly, the thickness of the primer layer 14 is preferably at most 20 nm, more preferably at most 10 nm.

### Step (b)

The photocurable resin composition is applied to the surface of the primer layer 14, and dried in a case where the photocurable resin composition contains a solvent, to form a photocurable resin layer 18.

### (Photocurable Resin Composition)

The photocurable resin composition contains a photocurable compound, and as the case requires, contains a fluorinated surfactant, a photopolymerization initiator, a solvent and another additive.

The photocurable compound is preferably a compound having a (meth)acryloyloxy group in view of a high curing rate, a high transparency of a cured product, and excellent adhesion to the primer layer 14.

The compound having a (meth)acryloyloxy group (hereinafter sometimes referred to as a (meth)acrylate compound) is preferably a compound having from 1 to 15 (meth)acryloyloxy groups per molecule.

The (meth)acrylate compound may be a compound having a relatively low molecular weight (hereinafter referred to as an acrylate monomer) or a compound having a relatively high molecular weight having at least two repeating units (hereinafter referred to as a (meth)acrylate oligomer).

The (meth)acrylate compound may be one consisting of at least one (meth)acrylate monomer, one consisting of at least one (meth)acrylate oligomer or one consisting of at least one (meth)acrylate monomer and at least one (meth)acrylate oligomer.

The (meth)acrylate oligomer may be a (meth)acrylate oligomer having a molecular structure having a molecular chain having at least two repeating units (such as a polyurethane chain, a polyester chain, a polyether chain or a polycarbonate chain) and a (meth)acryloyloxy group, and with a view to easily adjusting the flexibility and the surface hardness of the film after curing and in view of excellent adhesion to the primer layer 14, it is more preferably a urethane (meth)acrylate oligomer having a urethane bond and at least two (meth)acryloyloxy groups, further preferably a urethane (meth)acrylate oligomer having a urethane bond and from 6 to 15 (meth)acryloyloxy groups.

The proportion of the photocurable compound in the photocurable resin composition is preferably from 50 to 100 mass %, more preferably from 60 to 100 mass % per 100 mass % of the amount of components remaining as the cured resin in the photocurable resin composition. When the proportion of the photocurable compound is at least 50 mass %, a resin having a sufficient strength after curing can be obtained.

The photocurable resin composition preferably contains a fluorinated surfactant in view of flatness of the photocurable resin layer 18 and the releasability of the cured resin layer 16 from the mold 30.

The fluorinated surfactant is preferably a fluorinated surfactant having a fluorine content of from 10 to 70 mass %, more preferably a fluorinated surfactant having a fluorine content of from 10 to 40 mass %. The fluorinated surfactant may be water soluble or fat-soluble.

The fluorinated surfactant is preferably an anionic fluorinated surfactant, a cationic fluorinated surfactant, an amphoteric fluorinated surfactant or a nonionic fluorinated surfactant, more preferably a nonionic fluorinated surfactant in view of the compatibility in the photocurable resin composition and dispersibility in the cured resin layer 16.

The proportion of the fluorinated surfactant in the photocurable resin composition is preferably from 0.05 to 5 mass %, more preferably from 0.1 to 5 mass % per 100 mass % of the amount of components remaining as the cured resin in the photocurable resin composition. When the proportion of the fluorinated surfactant is at least 0.05 mass %, flatness of the photocurable resin layer 18 and the releasability of the cured resin layer 16 from the mold 30 will be favorable. When the proportion of the fluorinated surfactant is at most 5 mass %, a stably uniformly mixed state with other components in the photocurable resin composition is likely to be maintained, and the influence over the resin pattern shape after curing will be suppressed.

The photocurable resin composition preferably contains a photopolymerization initiator in view of photo-curing property.

The photopolymerization initiator may, for example, be an acetophenone photopolymerization initiator, a benzoin photopolymerization initiator, a benzophenone photopolymerization initiator, a thioxanthone photopolymerization initiator, an α-aminoketone photopolymerization initiator, an α-hydroxy ketone photopolymerization initiator, an α-acyloxime ester, benzoyl-(o-ethoxycarbonyl)-α-monooxime, acylphosphine oxide, glyoxyester, 3-ketocoumarin, 2-ethylanthraquinone, camphorquinone, tetramethylthiuram sulfide, azobisisobutyronitrile, benzoyl peroxide, a dialkyl peroxide or tert-butyl peroxypivalate. From the viewpoint of the sensitivity and compatibility, an acetophenone photopolymerization initiator, a benzoin photopolymerization initiator, an α-aminoketone photopolymerization initiator or a benzophenone photopolymerization initiator is preferred.

The proportion of the photopolymerization initiator in the photocurable resin composition is preferably from 0.01 to 5.0 mass %, more preferably from 0.1 to 3.0 mass % per 100 mass % of the amount of components remaining as the cured resin in the photocurable resin composition. When the proportion of the photopolymerization initiator is at least 0.01 mass %, curing will proceed with a small amount of light, whereby the time required for the photocuring process can be shortened. When the proportion of the photopolymerization initiator is at most 5.0 mass %, the photopolymerization initiator will easily be mixed uniformly with other components in the photocurable resin composition, and a decrease in the strength by a decrease of the molecular weight after photocuring can be suppressed.

The photocurable resin composition preferably contains a solvent. In a case where the photocurable resin composition contains a solvent, repelling is likely to occur when the photocurable resin composition is applied, and further, repelling will be promoted by heating at the time of drying. Accordingly, effects by the present invention tend to be remarkable by applying the production process of the present invention when the photocurable resin composition contains a solvent.

The solvent may, for example, be an ester, a ketone, an alcohol or a cyclic ether.

The proportion of the solvent in the photocurable resin composition is preferably set so that a desired film thickness can be obtained after drying depending upon the application means employed. By dilution with the solvent, an effect to reduce the viscosity of the photocurable resin composition, whereby the photocurable resin composition is easily applied to form a thin film, and an effect such that a thin film is easily obtained since the film thickness is reduced by evaporation of the solvent after application, are obtained.

The photocurable resin composition may contain other additives such as a photosensitizer, a photopolymerization inhibitor, a resin, metal oxide fine particles, a carbon compound, metal fine particles and another organic compound, within a range not to impair the effects of the present invention.

### (Formation of Photocurable Resin Layer)

As the method of applying the photocurable resin composition, preferred is a method capable of forming the photocurable resin layer 18 with a uniform film thickness in an area of at least 10 mm² at a stage prior to contact with the mold 30. As a comparison, there is a method of dropping the photocurable resin composition in droplets less than 10 mm², spreading them by a mold thin and flat. As compared with this method, by a means of preparing a substantially uniform coating film in an area of at least 10 mm² and then pressing a mold, a coating film can be prepared quickly and efficiently in transcription to a large area, and further uniformity of the film thickness can be increased in the entire area after curing. A method capable of forming the photocurable resin layer 18 in an area of at least 10 mm² may, for example, be a spin coating method, a die coating method, a dip coating method, a spray coating method, an ink jet method, a potting method, a roll coating method, a blade coating method, a gravure coating method, a casting method or a bar coating method. Effects by the present invention tend to be remarkable by applying the production process of the present invention, when the application method is a spin coating method, a die coating method, a dip coating method, a spray coating method, a blade coating method, a bar coating method, a roll coating method or a gravure coating method, since repelling is thereby likely to occur when the photocurable resin composition is applied. The coating method is particularly preferably a spin coating method, a die coating method, a dip coating method or a spray coating method in view of the apparatus cost, the accuracy of the film thickness control, etc.

In a case where the photocurable resin composition contains a solvent, a coating layer of the photocurable resin composition is preferably dried. The temperature for drying the coating layer is preferably at least 60° C. When the drying temperature is at least 60° C., evaporation of the solvent will be promoted, and drying will efficiently be carried out. Further, when the drying temperature is at least 60° C., the viscosity of the photocurable resin composition is decreased by heating, whereby the flowability tends to be high, and repelling tends to be promoted. Accordingly, effects by the present invention tend to be remarkable by applying the production process of the present invention when the drying temperature is at least 60° C. The upper limit of the drying temperature is preferably 200° C. with a view to suppressing heat decomposition of the photocurable resin composition. The drying time is preferably from 30 seconds to 5 minutes.

The thickness A (the thickness after drying when the photocurable resin composition contains a solvent) of the photocurable resin layer 18 is preferably at most 200 nm, more preferably at most 150 nm. When the thickness A is at most 200 nm, the thickness of the remaining film can be reduced, and repelling tends to occur when the photocurable resin composition is applied, and the cured resin layer 16 is likely to be peeled from the primer layer 14 when the mold 30 is separated. Accordingly, effects by the present invention tend to be remarkable by applying the production process of the present invention when the thickness A is at most 200 nm.

Further, the thickness A of the photocurable resin layer 18 is preferably at most the depth B of the reverse pattern (i.e. concaves) of the mold 30, preferably at most 90% of the depth B. When the thickness A is at most the depth B, the surplus photocurable compound not filled in the reverse pattern (concaves) tends to be small, whereby the thickness R of the remaining film can be reduced, and the uniformity of the thickness R of the remaining film will further improve. The thickness A is preferably the minimum thickness (theoretical thickness) with which a fine pattern 20 (i.e. convexes) having a height C required as a resist pattern can be formed when the entire photocurable resin layer 18 is filled in the reverse pattern (concaves) and no remaining film is formed, more preferably at least 110% of the theoretical thickness with a view to uniformly forming the fine pattern 20 (convexes) in a plane.

The thickness A is an average of the thicknesses of the photocurable resin layer 18 at 3 portions.

### Step (c)

By irradiating the photocurable resin layer 18 with light in a state such that the photocurable resin layer 18 is sandwiched between the mold 30 and the primer layer 14, the photocurable resin layer 18 is cured and a part of the photocurable compound in the photocurable resin composition is reacted with a functional group (such as a (meth)acryloyloxy group) derived from the silane coupling agent on the surface of the primer layer 14, to form a cured resin layer 16.

### (Mold)

As the material of the mold 30, a non-light-transmitting material or a light-transmitting material may be mentioned.

As the non-light-transmitting material, silicon, a metal (such a nickel, copper, stainless steel or titanium), SiC or mica may, for example, be mentioned.

As the light-transmitting material, silica glass, glass or a resin (such as polydimethylsiloxane, cyclic polyolefin, polycarbonate, polyethylene terephthalate or a transparent fluororesin) may, for example, be mentioned.

At least one of the mold 30 and the substrate 12 is made of a material which transmits at least 40% of light having a wavelength with which the photopolymerization initiator is reactive.

### (Reverse Pattern)

The mold 30 has a reverse pattern on its surface. The reverse patterns is a reverse pattern corresponding to the fine pattern 20 on the surface of an article to be obtained.

The reverse pattern consists of a plurality of concaves and convexes between the concaves. The concaves may, for example, be grooves extending on the surface of the mold or holes dotted on the surface.

The shape of the grooves may, for example, be linear, curved or bent. The grooves may be a plurality of stripes extending in parallel with one another.

The cross-sectional shape of the grooves in a direction perpendicular to the longitudinal direction may, for example, be rectangular, trapezoidal, triangular or semicircular.

The shape of the holes may, for example, be triangular prism, quadrangular prism, hexagonal column, cylindrical column, triangular pyramid, quadrangular pyramid, hexagonal pyramid, circular corn, hemispherical or polyhedral.

The width of the grooves (that is, the width of the grooves when the concaves are grooves) is preferably from 1 nm to 100 μm, more preferably from 1 nm to 10 μm, particularly preferably from 10 nm to 500 nm. The width of the grooves means the full width at half maximum in the cross section in a direction perpendicular to the longitudinal direction.

The width of the holes (that is, the width of the holes when the concaves are holes) is preferably from 1 nm to 100 μm, more preferably from 1 nm to 10 μm, particularly preferably from 10 nm to 500 nm. The width of the holes means the full width at half maximum in the cross section in a direction perpendicular to the longitudinal direction when the opening is elongated, or otherwise, means the minimum length of a line which passes the center of gravity in the horizontal section at a position of half the depth of the holes.

The depth B of the concaves is preferably from 1 nm to 100 μm, more preferably from 1 nm to 10 μm, further preferably from 10 nm to 500 nm.

Further, when the ratio of the depth B of the concaves to the width of the grooves (the depth B of the concaves/the width of the grooves) or the ratio of the depth B of the concaves to the width of the holes (the depth B of the concaves/the width of the holes) is at least 2, the adhesion between the mold 30 and the cured resin layer 16 tends to be high, and the cured resin layer 16 is likely to be peeled from the primer layer 14 when the mold 30 is separated. Accordingly, effects by the present invention tend to be remarkable by applying the production process of the present invention when the ratio (the depth B of the concaves/the width of the grooves) or (the depth B of the concaves/the width of the holes) is at least 2.

In an area where the reverse pattern is dense, the distance between the adjacent concaves is preferably from 1 nm to 100 μm, more preferably from 1 nm to 10 μm, further preferably from 10 nm to 1 μm. The distance between the adjacent concaves means the distance from the terminal edge of the upper side in the cross section of a concave to the starting edge of the upper side in the cross section of the adjacent concave.

The dimensions are averages of dimensions measured at three portions.

The minimum dimension of a convex is preferably from 1 nm to 100 μm, more preferably from 1 nm to 10 μm, further preferably from 10 nm to 500 nm. The minimum dimension means the minimum dimension among the width, length and depth of the concave.

### (Formation of Cured Resin Layer)

The pressure applied to the photocurable resin layer 18 from the mold 30 is preferably at least 0.05 MPa, more preferably at least 0.3 MPa. When the pressure is at least 0.05 MPa, contact between the mold 30 and the photocurable resin layer 18 tends to be promoted, and the contact failure tends to decrease. The pressure applied to the photocurable resin layer 18 from the mold 30 is preferably at most 50 MPa in view of the durability of the substrate 12 and the mold 30.

Sandwiching of the photocurable resin layer 18 between the mold 30 and the primer layer 14 may be carried out under atmospheric pressure or under reduced pressure. In the case of atmospheric pressure, a huge apparatus for pressure reduction will be unnecessary, the time for the step (c) will be shortened, and volatilization of components contained in the photocurable resin layer 18 will be suppressed. Sandwiching under reduced pressure is advantageous in that inclusion of bubbles at the time of sandwiching will be suppressed, and the photocurable resin is easily filed in the holes.

Light to be applied to the photocurable resin layer 18 may, for example, be ultraviolet light, visible light, infrared light, electron beam or radiant ray.

As a light source of the ultraviolet light, sterilization lamp, ultraviolet fluorescent lamp, carbon arc, xenon lamp, high pressure mercury lamp for copying, intermediate pressure or high pressure mercury lamp, ultrahigh pressure mercury lamp, electrodeless lamp, metal halide lamp or natural light may, for example, be mentioned.

Irradiation with light may be carried out under normal pressure or under reduced pressure. Further, it may be carried out in the air or in an inert gas atmosphere such as in a nitrogen atmosphere or in a carbon dioxide atmosphere.

In a case where the mold 30 is made of a non-light-transmitting material, light is applied from the opposite side of the substrate 12 (that is, the opposite side from a side where the mold 30 is disposed). In a case where the mold 30 is made of a light-transmitting material, light may be applied from either side of the substrate 12.

### Step (d)

The mold 30 is separated from the cured resin layer 16 to obtain an article 10 having a fine pattern 20 comprising the cured resin layer 16 on its surface.

As a method of separating the mold 30 from the cured resin layer 16, a method of fixing both by vacuum suction and moving one in a separating direction or a method of mechanically fixing both and moving one in a separating direction may, for example, be mentioned.

After the mold 30 is separated from the cured resin layer 16, the cured resin layer 16 may further be cured. The curing method may, for example, be heat treatment or light irradiation.

### Step (e)

The article 10 having a fine pattern 20 on its surface obtained in the step (d) may be subjected to an etching step i.e. the following step (e) in some cases in production of a semiconductor device or the like.

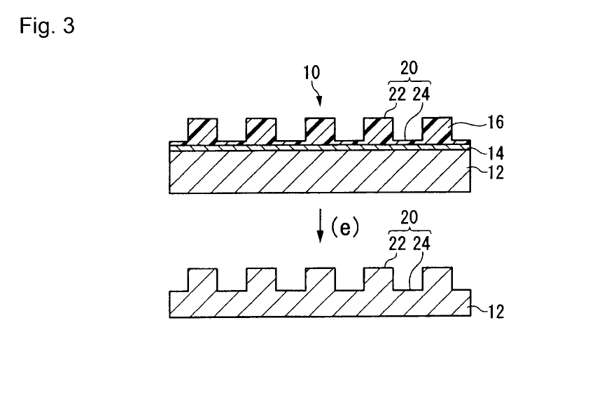

(e) A step of carrying out etching using as a resist the fine pattern 20 comprising the cured resin layer 16 to directly form a fine pattern 20 on the surface of the substrate 12, after the step (d), as shown in FIG. 3.

As the etching method, a known method may be mentioned, and preferred is an etching method using a halogen gas.

After etching, it is preferred to remove the resist remaining on the surface of the fine pattern 20 of the substrate 20. As the removal method, wet treatment by a peeling liquid or the like, dry treatment e.g. by oxygen plasma, or heat treatment at a temperature at which heat decomposition of the resist is promoted, may, for example, be mentioned.

### Function and Effect

According to the above-described process for producing an article 10 having a fine pattern on its surface of the present invention, since as the solution of a silane coupling agent to form the primer layer 14, one containing a silane coupling agent having a (meth)acryloyloxy group and a silane coupling agent having an epoxy group is used, peeling of the cured resin layer 16 from the primer layer 14 when the mold 30 is separated can be suppressed, and a defect of the cured resin layer 16 by repelling of the photocurable resin composition when the photocurable resin composition is applied to the surface of the primer layer 14 can be suppressed.

Such effects are remarkable under conditions where the cured resin layer 16 is likely to be peeled from the primer layer 14 when the mold 30 is separated, that is, in a case where the cured resin layer 16 is thin (a thickness of at most 200 nm), in a case where the reverse pattern of the mold 30 is fine (the distance between the concaves is at most 1 μm) or in a case where the reverse pattern of the mold has a high aspect ratio (an aspect ratio of at least 2). Here, the aspect ratio is defined by the ratio of the depth B of the concaves to the width of the grooves (the depth B of the concaves/the width of the grooves) or the ratio of the depth B of the concaves to the width of the holes (the depth B of the concaves/the width of the holes).

Further, such effects are remarkable under conditions where when the silane coupling agent is applied to the surface of the substrate 12, repelling of the silane coupling agent occurs and as a result, peeling of the cured resin layer 16 is likely to occur at a portion where formation of the primer layer 14 is insufficient, that is, in a case where the substrate is made of silicon, silica glass or glass.

Further, such effects are remarkable under conditions where when the photocurable resin composition is applied to the surface of the primer layer 14, repelling of the photocurable resin composition is likely to occur, that is, in a case where the cured resin layer 16 is thin (a thickness of at most 200 nm), in a case where the application method is a method capable of forming the photocurable resin layer in an area of at least 10 mm², or in a case where the resist is a solution containing a solvent.

### EXAMPLES

Now, the present invention will be described in further detail with reference to Examples. However, it should be understood that the present invention is by no means restricted thereto.

Examples 5 to 35, 40 and 41 are Examples of the present invention, and Examples 1 to 4 and 36 to 39 are Comparative Examples.

### (Thickness)

The thickness of the photocurable resin layer was measured by a table film thickness measurement instrument (manufactured by Filmetrics Japan, Inc., F20).

### (Repelling of Silane Coupling Agent)

The primer layer immediately after formation of the primer layer on the surface of the substrate was observed by a microscope and visually, and whether repelling of the silane coupling agent occurred or not was sensorily evaluated based on the following standards.

⊚: Repelling of the silane coupling agent not observed even by a microscope.

◯: Repelling of the silane coupling agent confirmed by observation with a microscope, but repelling of the silane coupling agent not visually observed.

×: Repelling of the silane coupling agent visually observed.

### (Peeling of Cured Resin Layer)

The photocurable resin layer was formed on the surface of the primer layer, a fine pattern was formed by a nanoimprint method, thereafter the cured resin layer was visually observed, and whether the cured resin layer was peeled or not was sensorily evaluated based on the following standards.

⊚: Peeling of the cured resin layer observed in none of five samples tested.

◯: Peeling of the cured resin layer observed in two or less samples in five samples tested.

×: Peeling of the cured resin layer observed in three or more samples in five samples tested.

### (Defect of Cured Resin Layer by Repelling of Photocurable Resin Composition)

The photocurable resin layer was formed on the surface of the primer layer, a fine pattern was formed by a nanoimprint method, thereafter the cured resin layer was visually observed, and whether a defect of the cured resin layer by repelling of the photocurable resin composition was present or not was sensorily evaluated based on the following standards.

⊚: No defect of the cured resin layer by repelling of the photocurable resin composition visually observed.

×: A defect of the cured resin layer by repelling of the photocurable resin composition visually observed.

### (Silane Coupling Agent)

KBM303: 2-(3,4-epoxycyclohexyl)ethyltrimethoxysilane (manufactured by Shin-Etsu Silicone)

KBM403: 3-Glycidoxypropyltrimethoxysilane (manufactured by Shin-Etsu Silicone)

KBM5103: 3-Acryloxypropyltrimethoxysilane (manufactured by Shin-Etsu Silicone)

KBM503: 3-Methacryloxypropyltrimethoxysilane (manufactured by Shin-Etsu Silicone)

### (Other Silane Compounds)

TEOS: Tetraethoxysilane (reagent manufactured by TOKYO CHEMICAL INDUSTRY CO., LTD.)

### Example 1

### (Step (a))

In a sample tube, 9 g of 2-propanol, 1 g of a 0.6 mass % nitric acid aqueous solution and 100 mg of KBM403 were weighed, followed by stirring for one hour to prepare a solution of a silane coupling agent.

The solution of a silane coupling agent was dropped on the surface of a circular silicon substrate (manufactured by SUMCO CORPORATION, thickness: 525 μm, <1.0. 0> face, one side mirror wafer, CZ method) having a diameter of 4 inches, followed by spin coating at 4,000 rpm for 20 seconds, and then heating was conducted on a hotplate at 130° C. for 10 minutes to form a primer layer having a thickness less than 10 nm. Whether repelling of the silane coupling agent occurred or not was confirmed. The results are shown in Table 1.

### (Step (b))

A photocurable resin composition comprising 5 mass % of U-6H (manufactured by Shin-Nakamura Chemical Co., Ltd., urethane acrylate oligomer), 3 mass % of IRGACURE907 (manufactured by BASF Japan Ltd., photopolymerization initiator), 3 mass % of SURFLON S-650 (manufactured by AGC SEIMI CHEMICAL CO., LTD., nonionic fluorinated surfactant) and isobutyl acetate was dropped on the surface of the primer layer, followed by spin coating at 3,000 rpm for 20 seconds, and then heating was conducted on a hotplate at 70° C. for one minute to form a photocurable resin layer having a thickness of 120 nm.

### (Step (c))

To the photocurable resin layer, a silica glass mold having a line/space fine pattern (line width of line: 60 nm, groove width of space: 60 nm, groove depth: 130 nm) was pressed under a pressure of 3 MPa in vacuum at 25° C. and firmly attached by using a nanoimprint device (manufactured by TOSHIBA MACHINE CO., LTD., ST50), and the photocurable resin layer was irradiated with ultraviolet light (2,000 mJ/cm²) in such a state.

### (Step (d))

The silica glass mold was peeled off in a vertical direction at a rate of 0.1 mm/sec, to obtain a silicon substrate having a fine pattern comprising a cured resin layer. Whether the cured resin layer was peeled or not, and whether a defect of the cured resin layer by repelling of the photocurable resin composition was present or not, were confirmed. The results are shown in Table 1.

### Examples 2 to 39

A silicon substrate having a fine pattern comprising a cured resin layer was obtained in the same manner as in Example 1 except that the type and the amount of the silane coupling agent and other silane compound contained in the solution of a silane coupling agent were changed as identified in Table 1. Whether repelling of the silane coupling agent occurred or not, whether the cured resin layer was peeled or not, and whether a defect of the cured resin layer by repelling of the photocurable resin composition occurred or not, are shown in Table 1 or 2.

### Examples 40 and 41

A glass substrate having a fine pattern comprising a cured resin layer was obtained in the same manner as in Examples 1 to 39 except that the substrate was changed to a 100 mm square glass (manufactured by Asahi Glass Company, Limited, thickness: 1 mm). Whether repelling of the silane coupling agent occurred or not, whether the cured resin layer was peeled or not and whether a defect of the cured resin layer by repelling of the photocurable resin composition occurred or not, are shown in Table 2.

TABLE 1

| | Epoxysilane *¹ | | Acrylsilane *² | | TEOS | Acrylsilane *² | Repelling of | Peeling of | Defect of cured |
|---|---|---|---|---|---|---|---|---|---|
| | | Amount | | Amount | Amount | Proportion | silane coupling | cured resin | resin layer by |
| Ex. | Type | (mg) | Type | (mg) | (mg) | (%) | agent | layer | repelling |
| 1 | KBM403 | 100 | — | 0 | 0 | 0 | ⊚ | x | ⊚ |
| 2 | KBM303 | 100 | — | 0 | 0 | 0 | ⊚ | x | ⊚ |
| 3 | KBM403 | 10 | — | 0 | 0 | 0 | ⊚ | x | ⊚ |
| 4 | KBM303 | 10 | — | 0 | 0 | 0 | ⊚ | x | ⊚ |
| 5 | KBM403 | 98 | KBM5103 | 2 | 0 | 2 | ⊚ | ∘ | ⊚ |
| 6 | KBM403 | 98 | KBM503 | 2 | 0 | 2 | ⊚ | ∘ | ⊚ |
| 7 | KBM303 | 98 | KBM5103 | 2 | 0 | 2 | ⊚ | ∘ | ⊚ |
| 8 | KBM303 | 98 | KBM503 | 2 | 0 | 2 | ⊚ | ∘ | ⊚ |
| 9 | KBM403 | 95 | KBM5103 | 5 | 0 | 5 | ⊚ | ⊚ | ⊚ |
| 10 | KBM403 | 95 | KBM503 | 5 | 0 | 5 | ⊚ | ⊚ | ⊚ |
| 11 | KBM303 | 95 | KBM5103 | 5 | 0 | 5 | ⊚ | ⊚ | ⊚ |
| 12 | KBM303 | 95 | KBM503 | 5 | 0 | 5 | ⊚ | ⊚ | ⊚ |
| 13 | KBM403 | 9.5 | KBM5103 | 0.5 | 0 | 5 | ⊚ | ⊚ | ⊚ |
| 14 | KBM403 | 9.5 | KBM503 | 0.5 | 0 | 5 | ⊚ | ⊚ | ⊚ |
| 15 | KBM303 | 9.5 | KBM5103 | 0.5 | 0 | 5 | ⊚ | ⊚ | ⊚ |
| 16 | KBM303 | 9.5 | KBM503 | 0.5 | 0 | 5 | ⊚ | ⊚ | ⊚ |
| 17 | KBM403 | 90 | KBM5103 | 10 | 0 | 10 | ⊚ | ⊚ | ⊚ |
| 18 | KBM403 | 90 | KBM503 | 10 | 0 | 10 | ⊚ | ⊚ | ⊚ |
| 19 | KBM303 | 90 | KBM5103 | 10 | 0 | 10 | ⊚ | ⊚ | ⊚ |
| 20 | KBM303 | 90 | KBM503 | 10 | 0 | 10 | ⊚ | ⊚ | ⊚ |

*¹ Epoxysilane = Silane coupling agent having an epoxy group.
*² Acrylsilane = Silane coupling agent having a (meth)acryloyloxy group.

TABLE 2

| | Epoxysilane *¹ | | Acrylsilane *² | | TEOS | Acrylsilane *² | Repelling of | Peeling of | Defect of cured |
|---|---|---|---|---|---|---|---|---|---|
| | | Amount | | Amount | Amount | Proportion | silane coupling | cured resin | resin layer by |
| Ex. | Type | (mg) | Type | (mg) | (mg) | (%) | agent | layer | repelling |
| 21 | KBM403 | 9 | KBM5103 | 1 | 0 | 10 | ⊚ | ⊚ | ⊚ |
| 22 | KBM403 | 9 | KBM503 | 1 | 0 | 10 | ⊚ | ⊚ | ⊚ |
| 23 | KBM303 | 9 | KBM5103 | 1 | 0 | 10 | ⊚ | ⊚ | ⊚ |
| 24 | KBM303 | 9 | KBM503 | 1 | 0 | 10 | ⊚ | ⊚ | ⊚ |
| 25 | KBM403 | 70 | KBM5103 | 30 | 0 | 30 | ⊚ | ⊚ | ⊚ |
| 26 | KBM403 | 50 | KBM5103 | 50 | 0 | 50 | ⊚ | ⊚ | ⊚ |
| 27 | KBM403 | 40 | KBM5103 | 60 | 0 | 60 | ⊚ | ⊚ | ⊚ |
| 28 | KBM403 | 40 | KBM503 | 60 | 0 | 60 | ⊚ | ⊚ | ⊚ |
| 29 | KBM303 | 40 | KBM5103 | 60 | 0 | 60 | ⊚ | ⊚ | ⊚ |
| 30 | KBM303 | 40 | KBM503 | 60 | 0 | 60 | ⊚ | ⊚ | ⊚ |
| 31 | KBM403 | 30 | KBM5103 | 70 | 0 | 70 | ∘ | ∘ | ⊚ |
| 32 | KBM403 | 30 | KBM503 | 70 | 0 | 70 | ∘ | ∘ | ⊚ |
| 33 | KBM303 | 30 | KBM5103 | 70 | 0 | 70 | ∘ | ∘ | ⊚ |
| 34 | KBM303 | 30 | KBM503 | 70 | 0 | 70 | ∘ | ∘ | ⊚ |
| 35 | KBM303 | 20 | KBM503 | 80 | 0 | 80 | ∘ | ∘ | ⊚ |
| 36 | — | 0 | KBM5103 | 100 | 0 | 100 | x | x | ⊚ |
| 37 | — | 0 | KBM503 | 100 | 0 | 100 | x | x | ⊚ |
| 38 | — | 0 | KBM5103 | 40 | 60 | 100 | ⊚ | ⊚ | x |
| 39 | — | 0 | KBM503 | 40 | 60 | 100 | ⊚ | ⊚ | x |
| 40 | KBM403 | 30 | KBM5103 | 70 | 0 | 70 | ∘ | ⊚ | ⊚ |
| 41 | KBM303 | 30 | KBM503 | 70 | 0 | 70 | ⊚ | ⊚ | ⊚ |

*1 Epoxysilane = Silane coupling agent having an epoxy group.
*2 Acrylsilane = Silane coupling agent having a (meth)acryloyloxy group.

### INDUSTRIAL APPLICABILITY

The process for producing an article having a fine pattern on its surface of the present invention is useful for production of a semiconductor device, an optical element, an antireflection member, biochips, microreactor chips, a recording medium, a catalyst carrier, a mold to be used for a nanoimprint lithography method, etc.

This application is a continuation of PCT Application No. PCT/JP2013/060653, filed on Apr. 8, 2013 which is based upon and claims the benefit of priority from Japanese Patent Application No. 2012-088633 filed on Apr. 9, 2012. The contents of those applications are incorporated herein by reference in their entireties.

### REFERENCE SYMBOLS

10: Article
12: Substrate
14: Primer layer
16: Cured resin layer
18: Photocurable resin layer
20: Fine pattern
22: Convex
24: Concave
30: Mold

What is claimed is:

1. A process for producing an article having a fine pattern on its surface, which is a process for producing an article comprising a substrate, a primer layer formed on the surface of the substrate and a cured resin layer formed on the surface of the primer layer, the cured resin layer having a fine pattern, the process comprising:
(a) a step of applying a solution of a silane coupling agent to the surface of the substrate to form the primer layer;
(b) a step of applying a photocurable resin composition to the surface of the primer layer to form a photocurable resin layer;
(c) a step of irradiating the photocurable resin layer with light in a state such that the photocurable resin layer is sandwiched between a mold having on its surface a reverse pattern of the fine pattern and the primer layer to cure the photocurable resin layer thereby to form the cured resin layer; and
(d) a step of separating the mold from the cured resin layer to obtain the article;
wherein as the solution of a silane coupling agent, one containing a silane coupling agent having a (meth)acryloyloxy group and a silane coupling agent having an epoxy group is used.

2. The process for producing an article having a fine pattern on its surface according to claim 1, wherein the proportion of the silane coupling agent having a (meth)acryloyloxy group is from 1 to 99 mass % per 100 mass % of the total amount of the silane coupling agent having a (meth)acryloyloxy group and the silane coupling agent having an epoxy group in the solution of a silane coupling agent.

3. The process for producing an article having a fine pattern on its surface according to claim 1, wherein the thickness of the photocurable resin layer is at most 200 nm.

4. The process for producing an article having a fine pattern on its surface according to claim 1, wherein the photocurable resin composition contains a fluorinated surfactant in an amount of from 0.05 to 5 mass % of the composition.

5. The process for producing an article having a fine pattern on its surface according to claim 1, wherein the photocurable resin composition contains a compound having a (meth)acryloyloxy group.

6. The process for producing an article having a fine pattern on its surface according to claim 1, wherein the method of applying the photocurable resin composition is a method capable of forming the photocurable resin layer in an area of at least 10 mm².

7. The process for producing an article having a fine pattern on its surface according to claim 1, wherein the photocurable resin composition containing a solvent is applied to the surface of the primer layer and heated to at least 60° C. to evaporate the solvent, thereby to form the photocurable resin layer.

8. The process for producing an article having a fine pattern on its surface according to claim 1, wherein the material of the substrate is silicon, silica glass or glass.

9. The process for producing an article having a fine pattern on its surface according to claim 1, wherein after the above step (d), etching is carried out using a fine pattern comprising the cured resin layer as a resist, to form a fine pattern on the surface of the substrate.
